(19) United States
(12) Patent Application Publication
(10) Pub. No.: US 2005/0180811 A1
(43) Pub. Date: Aug. 18, 2005

(54) Album pages

(76) Inventors: Robert Workman, Spanish Fork, UT (US); Alice Johnson, Springville, UT (US); Jenny Bressler, Driggs, ID (US); Shelli Christiansen, Lehi, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/781,566

(22) Filed: Feb. 18, 2004

(51) Int. Cl. B42F 13/00

(52) U.S. Cl. 402/79

(57) ABSTRACT

An album page for retaining visual material includes a first sleeve and a second plurality of sleeves that are attached to the first sleeve and form a living hinge thereinbetween. The second plurality of sleeves may be stacked, one on top of the next or positioned adjacent one anther. Each of the second plurality of sleeves can be lifted about its respective living hinge to allow viewing of visual materials positioned thereunder.

### BACKGROUND

1. Field of the Invention

The present invention relates generally to devices for retaining visual materials, such as photographs and colored or printed papers and other sheet-like materials. More particularly, the present invention relates to sheet protectors that form album pages to be incorporated into a photo album or scrapbook, with each of the sheet protectors including a plurality of pouches or pockets that are can be individually moved relative to the album page about a living hinge formed along one side thereof.

2. Description of the Art

Sheet protectors are devices that have one or more plastic sleeves in which sheet material such as photographs or documents may be inserted and viewed. Sheet protectors are manufactured for a number of consumer markets. For example, there are sheet protectors that are configured as leaves for photo albums. There are also sheet protectors for receiving a single sheet of paper, as well as multiple visual material such as trading cards (e.g., baseball cards).

One sheet protector disclosed in the art is shown and described in U.S. Pat. No. 6,390,714 to Bradley et al. Bradley teaches a customizable leaf for retaining visual material includes a first assembly and a second assembly. Each of the assemblies includes a front sheet and a back sheet attached together to form a margin and an accessible pocket. The sheets are made from an optically transparent material such as polypropylene. The sleeve is adapted to receive a background that may include graphics. The background is visible in the margins when received within the sleeve. One or more backgrounds may be provided, each with graphics, so that a user may select one of the backgrounds and then insert the selected background into the sleeve. When visual material such as a photograph is then inserted into one of the pockets, the background, particularly the graphics, is visible at the margins. The leaf is particularly suitable for albums, such photo albums, scrap books, card-collecting albums, and so on. The leaf may include a binding portion to enable easy binding in, for example, a standard three-ring, strap-bound, or post-bound binder to form such albums. In Bradley et al., however, the amount of material visual to a user is limited by the size of the leaf.

Thus, it would be advantageous to provide sheet protectors and album leaves that will enable a user to include with each leaf additional visual materials that have an area that is greater than the size of the leaf. These and other advantages will become apparent from a reading of the following summary of the invention and description of the illustrated embodiments in accordance with the principles of the present invention.

### SUMMARY OF THE INVENTION

Accordingly, an album page or leaf for retaining visual materials, such a photographs, graphical background materials and papers comprises a front sheet and a back sheet each formed from an optically transparent material. The front and back sheets are attached along three of their sides to form a pocket or sleeve for holding a sheet of material therein for viewing, such as photographic or graphical background material. By attaching three sides of the sheets together, one side is left unattached to provide an opening in the sleeve. A plurality of pockets, each formed from two sheets are coupled to the front sheet along one edge thereof.

Each of the plurality of pockets form a living hinge proximate one edge thereof to allow each of the plurality of pockets to be lifted relative to living hinge and thus relative to the front sheet. By arranging the plurality of pockets in a stacked configuration, substantially more visual material can be provided on each leaf than would otherwise be visible given the available surface area of the leaf.

In one embodiment, the size of each of the plurality of pockets is less than the size of the sleeve.

In another embodiment, the pockets are positioned proximate one another in a side-by-side arrangement.

In yet another embodiment, the pockets are positioned in a stacked arrangement, with each pocket at least partially positioned on top of an adjacent pocket.

In still another embodiment, the pockets form a margin on the front sheet. When a background is inserted into the sleeve, the background is visible in the margin.

In one embodiment, the living hinge that allows the pockets to be lifted relative to the front sheet is formed by a plastic weld.

In another embodiment, the living hinge is formed by an attachment portion integrally formed with said plurality of pockets for coupling the plurality of pockets to said front sheet.

In one embodiment, the attachment portion is sized to fit within a pocket attached to the front sheet with the attachment portion inserted into the pocket.

In another embodiment, the attachment portion is configured to be adhesively attached to the first sheet.

In still another embodiment, each of the components of the leaf are formed from optically transparent thermoplastic material. As such, the front and back sheets can be attached as by heat welding to form seams along the edges of the sheets.

In yet another embodiment, the leaf is provided with a binding portion configured for engaging with a binder, such as a three-ring binder.

Each of the pockets are sized to receive a visual image, such as a photograph. Thus, the pockets may be sized to fit typical photograph sizes, such as 2 inches by 2 inches, 3½ inches by 5 inches, 4 inches by 6 inches, 5 inches by 7 inches or 8 inches by 10 inches. Likewise, the front and back sheets may form a sleeve that is sized to fit a typical photograph or scrapbook album, such as about 8½ inches by 11 inches or 12 inches by 12 inches.

Additional aspects, features, and advantages of the present invention will become apparent to those skilled in the art from a consideration of the following detailed description taken in conjunction with the accompanying drawings. Moreover, any and all of the features described herein and combinations of such features are included within the scope of the present invention provided that the features of any such combination are not mutually inconsistent.

### BRIEF DESCRIPTION OF THE DRAWINGS

The foregoing summary, as well as the following detailed description of the preferred embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed. In the drawings:

FIG. 1 is a front view of a first embodiment of an album leaf in accordance with the principles of the present invention;

FIG. 2 is a side view of the album leaf illustrated in FIG. 1;

FIG. 3 is a bottom end view of the album leaf illustrated in FIG. 1;

FIG. 4 is a top end view of the album leaf illustrated in FIG. 1;

FIG. 5 is a front view of a second embodiment of an album leaf in accordance with the principles of the present invention;

FIG. 6A is a front view of a first embodiment of a pocket insert in accordance with the principles of the present invention;

FIG. 6B is a side view of the pocket insert illustrated in FIG. 6A;

FIG. 7A is a front view of a third embodiment of an album leaf in accordance with the principles of the present invention; and

FIG. 7B is a bottom end view of the album leaf illustrated in FIG. 7A.

### DETAILED DESCRIPTION OF THE ILLUSTRATED EMBODIMENTS

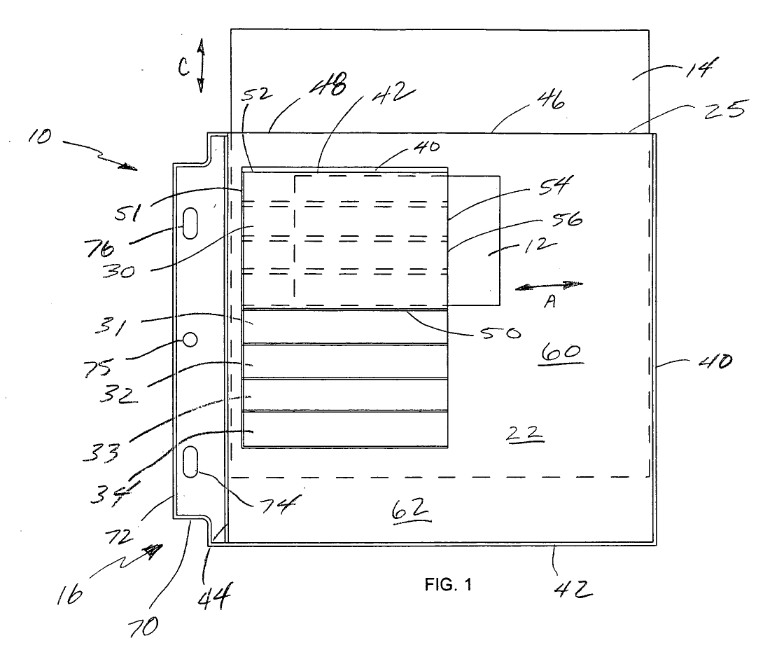

Referring to the drawings wherein like numerals indicate like elements throughout, there is shown in FIG. 1 an album page or binder leaf with a background is shown according to an exemplary embodiment of the invention and is indicated generally with reference numeral 10. In accordance with the principles of the present invention, the leaf 10 may be configured in any number of embodiments, each of which enables a user to display visual material in a customized, creative, and aesthetic manner. The word “leaf” is used herein in accordance with conventional book-binding vernacular as an element of a book, a binder, or an album containing two pages, i.e., a front and a back. For example, in many useful embodiments of the invention, the leaf 10 functions analogously to a photo page for a photo album. The leaf 10 may be configured to be permanently bound in a binder or an album or, alternatively, releasably bound such as with a three-ring binder, which will be described in detail below.

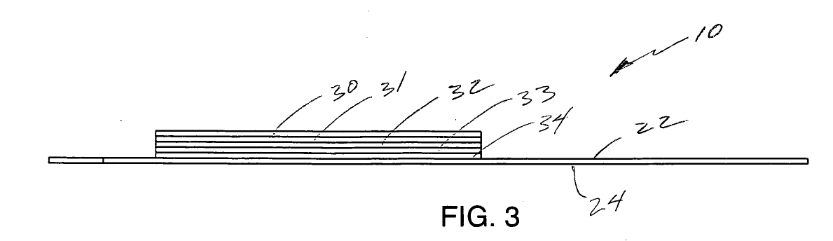

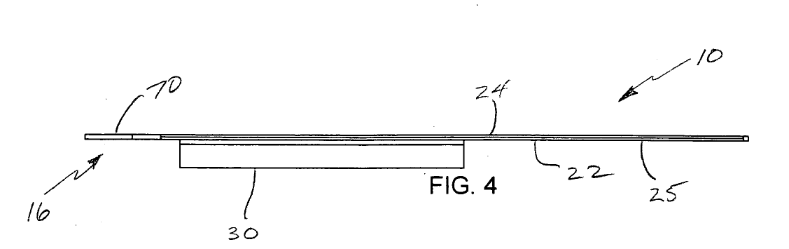

As shown in the embodiment of FIGS. 1, 2, 3 and 4, exemplary leaf 10 may be configured to retain one or more photographs 12 with a background 14 spatially disposed behind the photographs 12. The photograph 12 may be inserted into and out of the leaf 10 as indicated by arrow A. Similarly, the 22 along a respective side or edge 35-39 thereof. Each pocket 30-34 is provided with an attachment portion, such as attachment portion 40 that is bonded or otherwise attached, as by heat welding, to the front sheet 22. Because each pocket 30-34 is formed from a flexible, resilient material, such as a sheet of plastic, a living hinge 42 is formed in the pocket 30 so as to allow the pocket 30 to be lifted relative to the sheet 22 as it is pivoted about the living hinge 42. Each of the other pockets 31-34 are formed in a similar manner and attached to the sheet 22 to each form their own living hinges along their top edges.

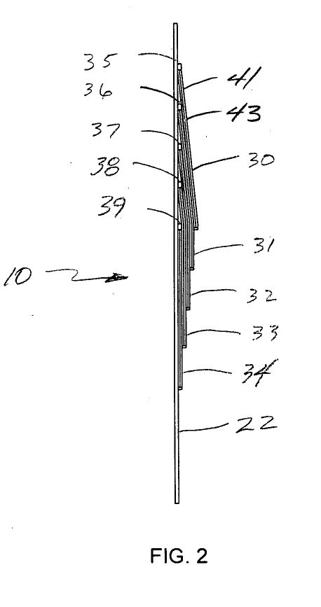

To form the sleeve 25, the sheets 22 and 24 are attached to one another to form a three-sided perimeter. As shown in FIG. 1, three seams 40, 42 and 44 form the sleeve 25. The seams may be formed by various methods for attaching the sheets together according to any number of methods as known in the art, for example, by heat or thermo-contact welding, radio-frequency (RF) welding, adhesive attachment, and so on. The top edges 46 of the sheets 22 and 24 are not attached to form an opening 48 such that the background sheet 14 can be inserted thereinbetween. A similar configuration is provided for each pocket 30-34. That is, each pocket 30-34 is formed from a pair of sheets 41 and 43 (see FIG. 2) that are attached background 14 may be inserted into and out of the leaf 10 as indicated by arrow C, thereby allowing the replacement by another background having a different design than background sheet 12, if desired. Accordingly, the leaf 10 configured in accordance with the principles of the present invention enables a user to create a customized album page, generally indicated at 16 displaying visual material accordingly to his or her own aesthetic sensibilities.

Prior to describing the present invention in more detail, a convention for the use of reference numbers for the purposes of this description is provided. For the sake of clarity in the drawings, certain elements are shown in phantom line, for example, the photo 12 and the portion of the background 14 received by the leaf 10 in FIG. 1.

As further illustrated, the leaf 10 generally includes a front sheet 22 and a back sheet 24 attached together to form a sleeve 25 or first pocket for receiving a background sheet 14 or other sheet of graphical material margin 26. Attached to the front sheet 22 are a plurality of smaller sleeves or pockets 30-34, each formed from a pair of sheets of material that are attached along three sides thereof. Thus, one side is open for inserting a sheet of material such as a photograph. Each pocket 30-34 is attached to the front sheet to one another along three sides 50, 51 and 52 thereof. An opening 54 is thus defined along the unattached side 56 of the pocket 30 for receiving a photo 12 or other relatively flat material. Each of the other pockets 31-34 are formed in a similar manner.

The exposed surface area 60 around the pockets 30-34 defines a margin 62 within which images or other graphical material attached or printed on the background sheet 14 can be visible without lifting the pockets 30-34. By including such pockets, however, the number of images or other graphical illustrations contained with the pockets 30-34 significantly increases the amount of material that can be viewed on a single leaf 10. Indeed, as each pocket 30-34 is lifted, both sides of the pockets can contain viewable material. Thus, for example, if the pockets 30-34 were provided with photos 12 that were sized to substantially fill each pocket, a total of 10 photos could be viewable in the five pockets 30-34. Moreover, When all of the pockets 30-34 are lifted, an viable image positioned under the pockets and attached to or printed on the sheet 14 is also viewable. Thus, the movable pockets 30-34 whether in a stacked arrangement as shown or provided in a side-by-side arrangement as will be described in more detail, substantially increase the amount of viewable material on a single leaf.

The sleeve 25 is configured to slidably receive one or more of the backgrounds 14 therein (for example, a front background sheet and a back background sheet). The sheets 22 and 24 forming the sheets and the sheets, such as sheets 41 and 43, forming the pockets 30-34 are made from visually transparent material such as polypropylene, as known in the art. When received within the sleeve 25, the background 14 is, therefore, visible through the sheets in the margin 62. In addition, any items received within the pockets 30-34 are visible through the sheets 41 and 43.

Because the leaf 10 may be provided to be inserted in a commercially available album or binder, the leaf 10 and more particularly the sleeve 25 may be of a size to accommodate a 12 inch by 12 inch or 8½ inches by 11 inches inch background sheet 14. Likewise, each of the pockets may be sized slightly larger than a typically sized photograph and thus configured to receive a typically sized photo such as 8 inches by 10 inches, 5 inches by 7 inches, 4 inches by 6 inches, 3½ inches by 5 inches, 2 inches by 3 inches or two inches by two inches, or the like. The background 14 may be printed with graphics 42 on each side thereof. Alternatively, if graphics are printed on only one side of the background 14, then a pair of backgrounds 14 may be received in the sleeve 40 at one time so that graphics are visible through the front sheets 22 and 24, respectively.

The leaf 10 illustrated in FIG. 1 is configured for being retained in a three-ring binder (not shown). As such, the leaf 10 includes a securing or binding portion 70 that is formed from the sheets 22 and 24 and includes a weld 72 about a perimeter thereof. Apertures 74, 75 and 76 are provided in the binding portion 70, each for receiving one ring of a three ring binder. Of course, those of skill in the art will appreciate that various other binding configurations could be incorporated into the securing portion 70 for attaching the leaf 10 to various types and/or configurations of binders or albums.

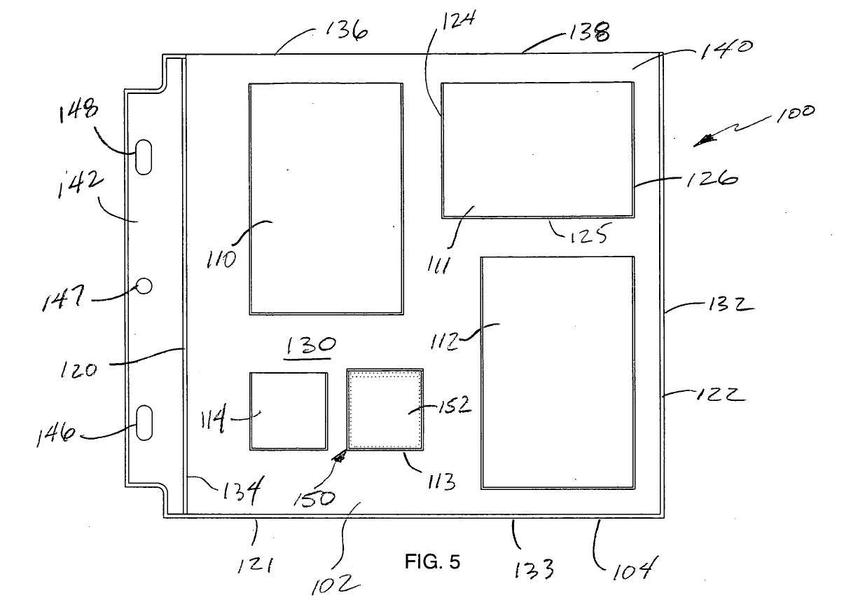

Referring to FIG. 5, a leaf, generally indicated at 100 in accordance with the principles of the present invention is illustrated. The leaf 100 is generally configured in a similar manner to the leaf 10 illustrated in FIG. 10 in that it is comprised of a front transparent sheet 102 and a back transparent sheet 104. The leaf 100, however, includes a plurality of fixed pockets 110-114. Each fixed pocket 110-114 is fixedly attached to the front sheet 102. Likewise, a plurality of fixed pocket could be affixed to the back sheet 104 in a similar manner and in the same size and position as the pockets 110-114 or of different sizes and positions. The front sheet 102 is attached to the back sheet 104 to form seams 120, 121 and 122. In addition, the pockets 110-114 are affixed to the front sheet 102 in a similar manner with a plurality of seams, such as seams 124, 125 and 126 that extend about the perimeter of each pocket. As illustrated, each of the pockets 110-114 may be of different sizes or of similar sizes depending upon the desired layout of the pockets 110-114. The seams 120-122 and 124-126 define margins 130 thereinbetween or exposed surface of the front sheet 102 for viewing material inserted into the sleeve formed between the front and back sheets 102 and 104, respectively. Thus, the front and back sheets 102 and 104, respectively, are attached along an outer edge 132, a bottom edge 133, and an inner longitudinal seam 134. The top edges 136 of the sheets 102 an d104 are not attached together, thereby defining a slit 138 for the sleeve 140.

In addition to forming the sleeve 140, the inner seam 134 defines a binding portion 142 of the leaf 100. The binding portion 142 may include a plurality of spaced through holes 146, 147 and 148 for engaging with a binding structure of a binder (not shown). As known in the art, the binding structure of a standard ring binder includes three rings spaced apart on center. Alternatively, the binding portion 142 may be configured for engaging with a binder or album incorporating a post binder or a strap hinge, both of which are known in the art. The binding portion 142 may be configured to permanently bind the leaves 100 in an album if desired.

As further illustrated in FIG. 5, the pocket 113 is provided with an insert, generally indicated at 150, coupled to the pocket 113 that provides plurality of similarly sized pockets 152, each pocket 152 positioned over the pocket 113. The pockets 152 expand the number of photos or other visual materials that can be held by the leaf 100 since similarly configured inserts could be provided for each of the other pockets 110, 111, 112 and 114. Thus, the size of the insert 150 can vary depending upon the size of the fixed pocket to which it is coupled. Also, because the insert 113 is selectively removable, the leaf 100 can be customized as desired to include more or less photographs or other visual materials.

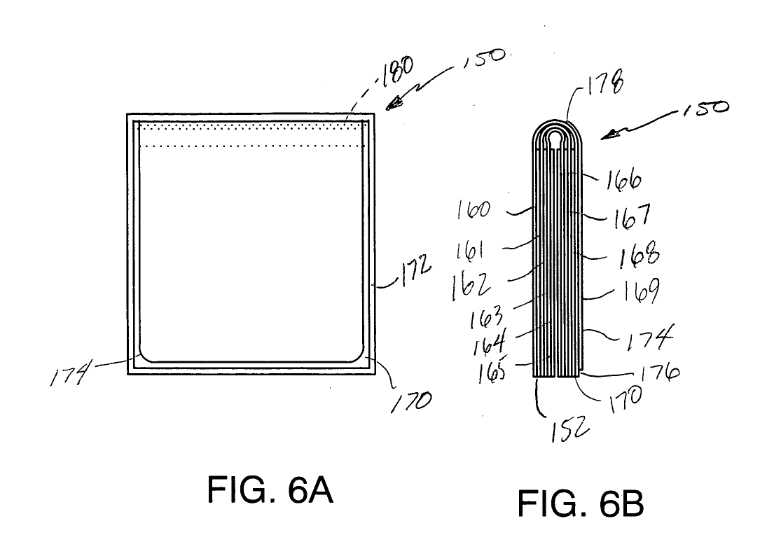

As further illustrated in FIGS. 6A and 6B, the insert 150 is comprised of a plurality of sheets 160, 161, 162, 163, 164, 165, 166, 168 and 169 of transparent material. Each sheet 160, 162 and 164 are folded proximate a midpoint thereof and each provide two pockets when combined with the sheets 161, 163, 165, 166, 167, and 168. That is, the sheet 160 and sheets 161 and 168 provides two pockets 152 and 170. Each of the pockets, such as pockets 152 and 170 are formed by a perimeter weld 172 that joins the sheets together in a manner as previously described herein.

An insert portion or sheet 174 is coupled to the back 1767 of the sheet 160 as by welding or other means of attachment known in the art proximate a top edge 178 thereof. The weld 180 also joins each of the sheets 160, 162 and 164 together so as to hold the sheets together into a single assembly. By inserting the insert portion 174 into a pocket 113 (as shown in FIG. 5), additional pockets are provided for the leaf 100. Likewise, the insert portion could be simply adhesively or mechanically attached directly to the front sheet to provide a plurality of pockets to the front sheet.

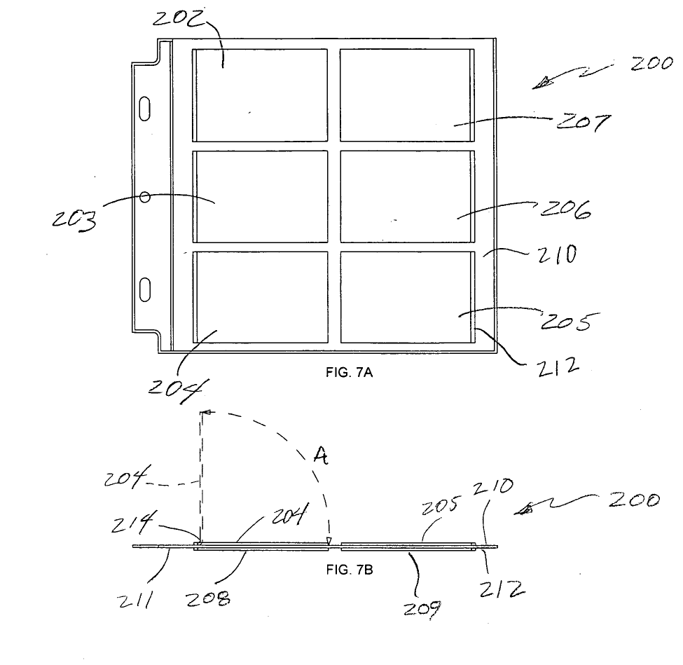

Referring now to FIGS. 7A and 7B, there is illustrated yet another embodiment of a leaf, generally indicated at 200, in accordance with the principles of the present invention. The leaf 200 has a general configuration similar to that of other embodiments illustrated and described herein, but is provided with a plurality of hinged pockets 202-207 that are arranged in a side-by-side configuration such that the pockets 202-207 do not overlap one another. Each pocket 202-207 is fixedly attached to the top sheet 210 of the leaf 200 along one side thereof as by plastic welding or adhesive, chemical or mechanical attachment. Thus, each pocket 202-207 includes an attachment portion 212 for coupling each pocket 202-207 to the top or front sheet 210. Because each pocket 202-207 is attached along one edge thereof and each pocket 202-207 is formed from a flexible, resilient material, such as a transparent plastic film, each pocket 202-207 can be pivoted or lifted and returned as illustrated by arrow A relative to the top sheet 210 from a first position, shown in solid lines to a second position as illustrated in dashed lines in FIG. 7B. Thus, the pocket 204 forms a living hinge 214 proximate the location of the attachment portion 212 to allow the pocket 204 to be lifted as illustrated. Each of the other pockets 202, 203, 305, 206 and 207 are similarly configured. It is further illustrated that similar pockets 208 and 209 are secured to the bottom sheet 211 of the leaf 200 to provide hinged pockets on the back of the leaf 200. By employing such hinged pockets 202-209, the area of the top and bottom sheets 210 and 211 can be selectively exposed to reveal visual materials contained within the sleeve defined between the top and bottom sheets 210 and 211 as has been previously described herein. As such, in accordance with the present invention, more materials are made visible than is otherwise possible with conventional fixed pocket leaves known in the art.

A leaf according to the present invention may be configured to hold in the pockets and storage media, such as CDs, CD-ROMs, DVDs, floppy disks, memory cards, magnetic tapes, or future electronic media, with the sleeve holding documentation associated with the storage media. The leaf may be configured to hold photographs of standard size, i.e., 3 inches by 5 inches, 4 inches by 6 inches, 5 inches by 7 inches, and 8 inches by 10 inches, as well as Polaroid.RTM.-type photographs, with the sleeve holding negatives of the photographs in addition to a background. In addition, the leaf may be configured to retain business cards, credit cards, stationery supplies, and any other item sized to be retained by the pockets.

While the present invention has been described with reference to certain embodiments, it is contemplated that upon review of the present invention, those of skill in the art will appreciate that various modifications and combinations may be made to the present embodiments without departing from the spirit and scope of the invention as recited in the claims. For example, a combination of fixed pockets and fixed, hinged pockets may be incorporated into the same leaf. The claims provided herein are intended to cover such modifications and combinations and all equivalents thereof. the leaves described herein may be configured to hold trading cards, greeting cards, articles for a scrap book, clippings, and any other visual materials that are desired to be displayed and viewed. In addition, text and/or graphics may be printed on or in the margins or the front or back sheets. Reference herein to specific details of the illustrated embodiments is by way of example and not by way of limitation. Accordingly, the present invention is not limited to that precisely as shown and described above but by the scope of the appended claims.

1. A leaf for retaining visual material, said leaf comprising:
a front sheet formed from an optically transparent material;
a back sheet formed from an optically transparent material and attached to said front sheet to form a sleeve thereinbetween; and
a plurality of pockets formed from first and second sheets of optically transparent material, each of said plurality of pockets attached to said front sheet along one edge, each of said plurality of pockets forming a living hinge proximate said one edge to allow each of said plurality of pockets to be lifted relative to living hinge and thus relative to said front sheet, and, each of said first and second sheets having a size that is less than a size of said front sheet.

2. The leaf of claim 1, wherein said plurality of pockets are positioned proximate one another in a side-by-side arrangement.

3. The leaf of claim 1, wherein said plurality of pockets are positioned in a stacked arrangement, with each pocket that is positioned on top of an adjacent pocket at least partially overlapping said adjacent pocket.

4. The leaf of claim 1, wherein said plurality of pockets form a margin on said front sheet, said sleeve for receiving a background so that the background is visible in said margin of said front sheet when received within said sleeve.

5. The leaf of claim 1, wherein said living hinge is formed by a plastic weld.

6. The leaf of claim 1, wherein said plurality of pockets includes an attachment portion integrally formed with said plurality of pockets for coupling said plurality of pockets to said front sheet.

7. The leaf of claim 6, further including at least one pocket attached to said front sheet, said attachment portion sized to fit within said at least one pocket for coupling said plurality of pockets to said front sheet.

8. The leaf of claim 6, wherein said attachment portion is configured for being adhesively attached to said first sheet.

9. The leaf of claim 1, wherein said front and back sheets and said plurality of pockets are formed from a thermoplastic material.

10. The leaf of claim 1, wherein said front sheet is attached to said back sheet by heat welding to form seams along at least three edges thereof.

11. The leaf of claim 1, further comprising a binding portion configured to engage with a binder.

12. The leaf of claim 11, wherein said binding portion is configured to engage with a three-ring binder.

13. The leaf of claim 1, wherein said plurality of pockets are sized to be one of about 2 inches by 2 inches, 3½ inches by 5 inches, 4 inches by 6 inches, 5 inches by 7 inches and 8 inches by 10 inches.

14. The leaf of claim 13, wherein said front and back sheets are sized to form a pocket of one of about 8½ inches by 11 inches and 12 inches by 12 inches.

15. An album comprising:
a binder including a binding structure;
a plurality of leaves, each said leaf including:
a front sheet formed from an optically transparent material;
a back sheet formed from an optically transparent material and attached to said front sheet to form a sleeve thereinbetween; and
a plurality of pockets formed from first and second sheets of optically transparent material, each of said plurality of pockets attached to said front sheet along one edge, each of said plurality of pockets forming a living hinge proximate said one edge to allow each of said plurality of pockets to be lifted relative to living hinge and thus relative to said front sheet, and, each of said first and second sheets having a size that is less than a size of said front sheet.

16. The leaf of claim 15, wherein said plurality of pockets are positioned proximate one another in a side-by-side arrangement.

17. The leaf of claim 15, wherein said plurality of pockets are positioned in a stacked arrangement, with each pocket that is positioned on top of an adjacent pocket at least partially overlapping said adjacent pocket.

18. The leaf of claim 1, wherein said plurality of pockets form a margin on said front sheet, said sleeve for receiving a background so that the background is visible in said margin of said front sheet when received within said sleeve.

19. The leaf of claim 1, wherein said living hinge is formed by a plastic weld.

20. The leaf of claim 1, wherein said plurality of pockets includes an attachment portion integrally formed with said plurality of pockets for coupling said plurality of pockets to said front sheet.

21. The leaf of claim 20, further including at least one pocket attached to said front sheet, said attachment portion sized to fit within said at least one pocket for coupling said plurality of pockets to said front sheet.

22. The leaf of claim 20, wherein said attachment portion is configured for being adhesively attached to said first sheet.

23. The leaf of claim 1, wherein said front and back sheets and said plurality of pockets are formed from a thermoplastic material.

24. The leaf of claim 1, wherein said front sheet is attached to said back sheet by heat welding to form seams along at least three edges thereof.

24. The leaf of claim 1, further comprising a binding portion configured to engage with a binder.

25. The leaf of claim 24, wherein said binding portion is configured to engage with a three-ring binder.

26. The leaf of claim 15, wherein said plurality of pockets are sized to be one of about 2 inches by 2 inches, 3½ inches by 5 inches, 4 inches by 6 inches, 5 inches by 7 inches and 8 inches by 10 inches. 15. A method for customizing an album, said method comprising:

27. The leaf of claim 26, wherein said front and back sheets are sized to form a pocket of one of about 8½ inches by 11 inches and 12 inches by 12 inches.
